(19) United States
(12) Patent Application Publication
(10) Pub. No.: US 2026/0079968 A1
(43) Pub. Date: Mar. 19, 2026

(54) SELF-CORRECTING LARGE LANGUAGE MODEL-BASED ACTION INVOCATION FOR A CONVERSATIONAL INTERFACE

(71) Applicant: Schlumberger Technology Corporation, Sugar Land, TX (US)

(72) Inventors: Vishal LAD, Pune (IN); Prashanth PILLAI, Pune (IN)

(21) Appl. No.: 19/328,630

(22) Filed: Sep. 15, 2025

(30) Foreign Application Priority Data
Sep. 13, 2024 (IN) 202411069442

(51) Int. Cl. G06F 16/332; G06F 16/338

(52) U.S. Cl. CPC G06F 16/3325; G06F 16/338

(57) ABSTRACT

An LLM-powered search engine receives a natural language query from a conversational interface. The conversational interface is a first section of a user interface. The LLM-powered search engine generates a first response including a natural language summary, a data payload and an action recommendation. The data payload is validated with respect to the action recommendation to obtain a validation result. If the validation result is an error result, a correction LLM generates a correction prompt based on the error result and the first response. The LLM-powered search engine processes the correction prompt to generate a second response. A second data payload of the second response is validated with respect to a second action recommendation of the second response, to obtain a second validation result.

### CROSS-REFERENCE TO RELATED APPLICATIONS

This application claims benefit to India application No. 202411069442, filed in India on Sep. 13, 2024, and which is incorporated herein by reference.

### BACKGROUND

Users increasingly rely on conversational interfaces powered by large language models (LLMs) to retrieve and interact with complex datasets in many domains. The user applications implemented for these interactions may be expected to support downstream operations such as data visualization, export, and workflow execution. Additionally, the user applications are expected to integrate with LLMs, to provide features for returning relevant information in response to natural language queries. The responses of the LLMs may be expected to include options for, or results of, performing downstream operations of visualization and workflow execution.

The integration of LLMs into the user applications introduces technical limitations. When an LLM generates a response that includes structured data, visual payloads, or action recommendations, the correctness and completeness of the data payload may affect the usability of the system. Errors such as malformed database queries, missing image data, or incomplete plotting instructions may prevent user applications from rendering viewers or executing workflows, leading to operational inefficiencies. Invalid or incomplete responses from LLMs may involve manual troubleshooting and prompt modification.

### SUMMARY

In general, an LLM-powered search engine receives a natural language query from a conversational interface. The conversational interface is a first section of a user interface. The LLM-powered search engine generates a first response including a natural language summary, a data payload and an action recommendation. The data payload is validated with respect to the action recommendation to obtain a validation result. If the validation result is an error result, a correction LLM generates a correction prompt based on the error result and the first response. The LLM-powered search engine processes the correction prompt to generate a second response. A second data payload of the second response is validated with respect to a second action recommendation of the second response, to obtain a second validation result.

Other aspects of one or more embodiments will be apparent from the following description and the appended claims.

### BRIEF DESCRIPTION OF DRAWINGS

FIG. 1 shows a computing system, in accordance with one or more embodiments.

FIG. 2 shows a flowchart of a method, in accordance with one or more embodiments.

FIG. 3 shows a flowchart of a method, in accordance with one or more embodiments.

FIG. 4 shows an example of a catalog of viewer types, in accordance with one or more embodiments.

FIG. 5 shows an example implementation of a generative AI-powered assistant, in accordance with one or more embodiments.

FIG. 6 shows an example of a document view, in accordance with one or more embodiments.

FIG. 7 shows an example of a map view and a workflow action, in accordance with one or more embodiments.

FIG. 8 shows an example of a plot view, in accordance with one or more embodiments.

FIG. 9 shows an example of a grid view, in accordance with one or more embodiments.

FIGS. 10.1 and 10.2 show a computing system, in accordance with one or more embodiments.

Like elements in the various figures are denoted by like reference numerals for consistency.

### DETAILED DESCRIPTION

In general, self-correcting large language model-based action invocation for a conversational interface that includes a generative artificial intelligence (AI) assistant. The generative AI assistant operates through a conversational interface to perform intelligent search and action execution in industrial and oil and gas enterprise domains. The AI assistant operates using a self-correction loop of validating domain-specific data obtained from responses generated by an LLM-powered search engine. If the domain-specific data does not pass validation checks for a set of intended actions using the data, a correction LLM analyzes the data and the validation error to generate a prompt that includes specific instructions to address and remedy the error. The prompt is processed by the LLM-powered search engine, which generates a response in accordance with the specific instructions. The self-correction loop is iterated until the data included in the response is validated for the intended action.

A user initiates a natural language query through a conversational interface, which is rendered in a first section of a user interface of the AI assistant. The query is processed by an LLM-powered search engine, which generates a response. The response may include a natural language summary, a data payload and an action recommendation. The response may include database records, visual data, or instructions for downstream operations such as data export or workflow initiation. A screening tool validates the data payload against the recommended action to ensure that the inputs are present and correctly formatted. If the validation fails, a correction LLM generates a correction prompt based on the error and the original response, which is processed by the LLM-powered search engine to generate additional responses in one or more iterations of the self-correcting loop. In cases where the validation succeeds, and the action recommendation is a view operation, a view coordinator invokes one or more viewing tools to render the appropriate viewer in a viewer section of the user interface, based on the schema type and data context of the data payload. Additionally, a workflow coordinator may be triggered to execute domain-specific workflows, either by launching application interfaces or invoking backend services.

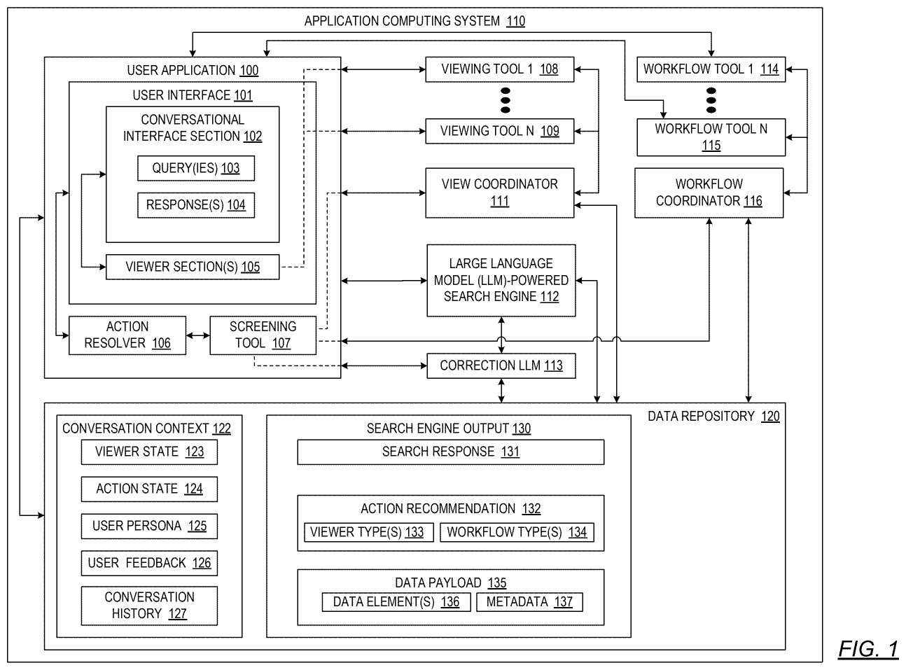

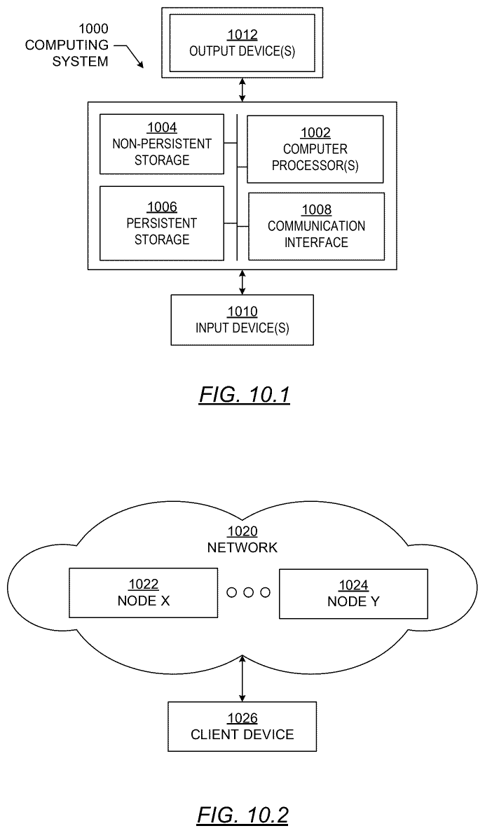

Attention is now turned to the figures. FIG. 1 shows a computing system, in accordance with one or more embodiments. The system shown in FIG. 1 may include an application computing system (110). The application computing system (110) is one or more computer processors, data repositories, communication devices, and supporting hardware and software. The application computing system (110) may be in a distributed computing environment. The application computing system (110) includes a computer processor. The computer processor is one or more hardware or virtual processors which may execute computer-readable program code that defines one or more applications, such as the user application (100), the viewer tool(s) (108) and (109), the view coordinator (111), the large language model (LLM)-powered search engine (112), the correction LLM (113), the workflow tools (114) and (115), and the workflow coordinator (116). An example of the computer processor is described with respect to the computer processor(s) (10002) of FIG. 10.1. Thus, the application computing system (110) is configured to execute one or more applications, such as the user application (100), the viewer tool(s) (108) and (109), the view coordinator (111), the LLM-powered search engine (112), the correction LLM (113), the workflow tools (114) and (115), and the workflow coordinator (116). An example of a computer system and network that may form the application computing system (110) is described with respect to FIG. 10.1 and FIG. 10.2.

The system shown in FIG. 1 includes a data repository (120). The data repository (120) is a type of storage unit or device (e.g., a file system, database, data structure, or any other storage mechanism) for storing data. The data repository (120) may include multiple different, potentially heterogeneous, storage units and/or physical storage devices.

The data repository (120) includes a conversation context (122). The conversation context (122) within the data repository (120) serves as a centralized memory structure for orchestration of view rendering, workflow execution, and corrective actions across the application computing system (110). The conversation context (122) includes a viewer state (123), which stores the current configuration and interaction details of active viewers, such as the current page number for document viewers, zoom level for map viewers, selected records in grid viewers, and displayed logs in log viewers. The conversation context (122) further includes an action state (124), which tracks the most recent actions triggered by the user or recommended by the LLM-powered search engine (112). The action state (124) may include the type of action, execution status, and associated payloads and identifiers. The conversation context (122) further includes a user persona (125), which encapsulates user-specific attributes such as role, preferences for viewer types or data formats, access permissions, and domain-specific configurations. Additionally, the conversation context (122) includes a user feedback (126), which captures explicit feedback from the user, such as thumbs-up or thumbs-down on responses or viewer outputs. The user feedback (126) may inform the LLM-powered search engine (112) and the correction LLM (113) during correction loops. Finally, the conversation context (122) includes a conversation history (127), which maintains a chronological log of the user queries and system responses. The conversation history (127) serves as long-term context tracking for multi-turn conversations and ensures coherence and relevance in responses generated by the LLM-powered search engine (112) and the correction LLM (113).

The data repository (120) further includes a search engine output (130). The search engine output (130) is generated by the LLM-powered search engine (112) and serves as the primary structured response to a user query within the application computing system (110). The search engine output (130) includes multiple components that collectively inform viewer rendering, workflow execution, and action orchestration. The search response (131) includes a natural language summary generated by the large language model-powered search engine (112) based on information retrieved from various data sources. The data sources may include relational databases, vector databases, graph databases, and unstructured document repositories proprietary to the enterprise in which the application computing system (110) is hosted. The search response (131) may include reference links to source documents, summaries of domain-specific data, and contextual insights relevant to the user query.

The search engine output (130) further includes an action recommendation (132), used by components such as the action resolver (106), screening tool (107), view coordinator (111), and workflow coordinator (116). The action recommendation (132) includes viewer type(s) (133). The viewer type(s) (133) specify the appropriate viewer tools to be rendered based on the data types and schema of data elements of the retrieved data payload. The viewer type(s) (133) may include document viewers, log viewers, map viewers, grid viewers, image viewers, trace viewers, and chart viewers. The viewer type(s) (133) each have corresponding viewing tools. For example, viewing tool 1 (108) may be a document viewing tool, viewing tool N (109) may be a map viewing tool, etc. The viewer type(s) (133) direct the invocation of the corresponding viewing tool according to the nature of the data and the user's intent. The action recommendation (132) also includes workflow type(s) (134), which identify domain-specific workflows to be triggered. The domain-specific workflows may include exporting data to particular format (e.g., comma separated value, etc.), creating data packages, or invoking external applications or Application Programming Interfaces (APIs) for interpretation tasks. In a similar manner, the workflow types (134) may correspond to the workflow tools, for example, workflow tool 1 (114) may be an external application, workflow tool N (115) may export data to CSV.

The search engine output (130) further includes a data payload (135). The data payload (135) includes the actual data element(s) (136) retrieved from the underlying data sources, along with associated metadata (137). The data element(s) (136) may include structured records, tabular data, image strings, plot data, or document references. The metadata (137) may provide contextual information such as schema identifiers, record IDs, and source attributes. The action resolver (106) may use the search engine output (130) to determine executable actions. The search engine output (130) may further be used by the view coordinator (111) to render appropriate viewers, and by the screening tool (107) to validate the completeness and correctness of the data and instructions. The search engine output (130) may be backed up in the conversation context (122) to maintain continuity and support self-correction workflows initiated by the correction LLM (113).

The application computing system (110) further includes a user application (100). The user application (100) is software or application-specific hardware that serves as the primary interface through which a user interacts with the application computing system (110). The user application (100) may serve as a generative AI-powered assistant specialized for oil and gas personnel, including data managers, geoscientists, and engineers. The user application (100) may be used to interact with complex subsurface and operational data using natural language queries. Upon receiving a query, the user application (100) may invoke the LLM-powered search engine (112), which retrieves information from various structured and unstructured data sources, including relational databases, vector databases, graph databases, and document repositories. The user application (100) includes a user interface (101). The user interface (101) further includes a conversational interface section (102). The conversational interface includes widgets where a user enters natural language queries (103), and widgets for displaying natural language summaries of responses (104). The user interface (101) further includes viewer sections (105) for dynamic rendering of data-driven components. The user application (100) receives and displays responses generated by the LLM-powered search engine (112), which may include the search engine output (130), having the search response (131), action recommendation (132), and data payload (135). The user application (100) may render visualizations generated by viewer tools in the viewer section(s) (105) of the user interface (101).

The user application (100) may not directly invoke the LLM-powered search engine (112) during viewer section transitions. Viewing tools may operate independently using the data already retrieved and rendered. Additionally, the viewing tools rendering visualizations in the viewer sections of the user application (100) may internally query additional data sources to enrich the displayed content. The user application (100) is modular and extensible for integration of new viewing tools and workflow tools as desired by evolving user specifications and domain-specific applications.

The user application (100) further includes an action resolver (106). The action resolver (106) is software or application-specific hardware, which, when executing on the computer processor, interprets the action recommendation generated by the LLM-powered search engine (112). The action recommendation may indicate performing either a viewing operation or a domain-specific workflow. Upon receiving the response from the search engine, the action resolver (106) may extract the action recommendation and determine the nature of the recommended action. If the action is a viewing operation, the action resolver (106) may delegate to the view operator to identify the appropriate viewer type and invoke the corresponding viewing tool. If the action involves execution of a workflow or data export, the action resolver (106) may coordinate with the modify/generation operator to trigger the appropriate client-side function, such as exporting a CSV file, creating a data package, or invoking a domain workflow via an API.

The action resolver (106) may also serve as the entry point for validation. Before any action is executed or viewer is rendered, the action resolver may forward the response to the screening tool (107) for verification. The screening tool (107) is a validation engine in the user application (100) that performs type-specific validation checks on the data payload with respect to the recommended action. In one or more embodiments, the screening tool (107) may be invoked by the action resolver (106). The data payload may include data elements of diverse types, including image data, plot data, database queries, structured records, unstructured data. The data payload may further include associated metadata such as record identifiers and schema types.

The screening tool (107) may perform type-specific validation checks based on the nature of the data. For image data, the screening tool (107) may verify that the image string is present, properly formatted, and decodable. For example, images may be transmitted as base64-encoded strings for portability and compatibility with JSON-based payloads. The screening tool (107) may check for a valid prefix such as data:image/png; base64, and attempt to decode the string. If the image string data is missing, corrupted, or improperly encoded, the screening tool (107) may generate the error code “IMAGE NOT FOUND.”

For plot data, the screening tool (107) may validate syntax and semantics. Plot data may include of numerical arrays intended for visualization in charts such as line graphs or bar charts. The screening tool (107) may verify that the data is in a valid format, that keys such as x and y are present, and that the arrays are equal in length. Plot data may be structured as an object in which each key corresponds to a specific dimension or variable in the plot. Commonly used keys may include “x” and “y”, which represent the horizontal and vertical axes of a chart, respectively. Each key may map to an array of numerical values, and these arrays are of equal length to ensure that each x-value has a corresponding y-value, forming valid coordinate pairs for plotting. Thus, the screening tool may check that both the “x” and “y” keys are present, and that the associated arrays are equal in length. Further, the screening tool may check that the values within the arrays are numerical and fall within acceptable ranges for visualization. This validation checks whether the plot data is syntactically and semantically correct before the plot data is rendered. The screening tool may also check that the values are numerical and within reasonable ranges. If the plot data is malformed or insufficient, the error code “PLOT DATA INCORRECT” may be generated.

For database queries, the screening tool (107) may parse the query string and check for valid syntax. Queries may be generated dynamically by the LLM-powered search engine. The screening tool may confirm that the fields and filters are present and that the query is safe to execute. If the query is invalid or incomplete, the error code “INVALID QUERY SYNTAX” may be triggered.

For domain workflows, the screening tool (107) may verify that the input parameters are present. Domain workflows may involve launching a domain-specific application or calling an API endpoint with structured parameters such as pressure, temperature, or well identifiers. If any inputs are missing, the screening tool may trigger the error code “DOMAIN WORKFLOW ERROR.”

For workflow operations such as CSV creation or data package generation, the screening tool (107) may check whether the relevant data is present and properly structured. If the data payload lacks the content, the error code “CREATE PACKAGE ERROR” may be triggered.

If any validation check fails, the screening tool may log the error type and send both the error and the original LLM output to the correction LLM (113), which functions as a self-correction system. If the data payload passes validation, the screening tool (107) may return the result to the action resolver (106).

The application computing system (110) further includes an LLM-powered search engine (112). The LLM-powered search engine (112) is a generative AI-based system designed to process natural language queries and retrieve relevant information from both structured and unstructured data sources. For structured sources such as relational databases, the LLM-powered search engine (112) generates queries in database query languages such as SQL and Lucene to access and extract records. For unstructured sources, including document repositories and vector databases, semantic search techniques, embedding similarity, and prompt-based retrieval may be used to locate and synthesize relevant content. Once the data is retrieved, the LLM-powered search engine (112) may generate a multi-part output that includes a natural language summary of the findings, a data payload containing the retrieved records or visual data, and an action recommendation object. The action recommendation may instruct downstream components to render specific viewers, export data, or trigger domain-specific workflows. The LLM-powered search engine (112) may be prompted to tailor the search engine output format based on the query context, user preferences, or system specifications. Examples of large language models (LLMs) that can power an LLM-powered search engine (112) include GPT-4® by OpenAI, CLAUDE® by Anthropic, PaLM 2 and Gemini by Google DEEPMIND®, and LLAMA® by Meta. The LLM model understands natural language queries, generates structured outputs, and synthesizes information from diverse sources. When fine-tuned on domain-specific datasets such as OSDU (Open Subsurface Data Universe), the aforementioned LLMs may be optimized to understand oil and gas terminology, schema structures, and data relationships. Fine-tuning enhances the model's ability to generate precise database queries, interpret geoscience and engineering data, and produce contextually relevant summaries and action recommendations.

The application computing system (110) further includes a correction LLM (113). The correction LLM (113) is a specialized large language model that operates as part of a self-correcting loop within the broader LLM-powered search engine (112) system. The correction LLM (113) is invoked to analyze errors identified during the screening phase and generate corrective prompts to recover from incomplete, invalid, or malformed outputs. In one or more embodiments, the correction LLM (113) may be invoked by the screening tool (107). The correction LLM (113) may then perform a reasoning task to identify the root cause of the failure, and further, construct a correction prompt that addresses the deficiency. The correction prompt may be sent back to the LLM-powered search engine (112), which reprocesses the query and attempts to generate a corrected output.

In one or more embodiments, the correction LLM (113) may operate as a separate model instance. In other embodiments, the correction LLM (113) may operate as a distinct workflow using the same underlying model as the LLM-powered search engine (112), depending on the system embodiment. The correction LLM (113) maintains access to the conversational context, including query history, viewer statements, and user feedback, for generating corrections that are in accordance with the user's intent and prior interactions. In cases where the correction loop exceeds a pre-defined recursion limit, the correction LLM (113) may escalate the issue by prompting the user for additional input or suggesting alternative data sources.

Examples of models that can serve as the correction LLM (113) include GPT-4, Claude, PaLM 2, and LLaMA, particularly when configured with reasoning capabilities and fine-tuned for error detection and prompt regeneration. In domain-specific implementations, such as those involving OSDU data, the correction LLM (113) may be fine-tuned to recognize schema-specific validation rules, expected data formats, and domain workflows. Thus, the correction LLM (113) may generate highly targeted and context-aware corrections.

The application computing system (110) further includes a view coordinator (111). The view coordinator (111) is software or application-specific hardware, which, when executing on the computer processor, orchestrates the operation of domain-specific viewing tools based on the data returned by the LLM-powered search engine (112). In one or more embodiments, upon receiving a response that includes a data payload and an action recommendation for a viewer operation, the view coordinator (111) may analyze the schema type and record identifiers associated with the data element of the data payload. The view coordinator (111) may further determine the appropriate viewing tool to invoke. For example, a document viewing tool may be invoked for schema types like Well, Wellbore, SeismicSurvey, or Document. A log viewing tool may be invoked for schema types such as WellLog, LogCurve, or WellboreTrajectory. An image viewing tool may be invoked for schema for types such as File.Generic, Seismic2DImage, or WellboreImage.

The view coordinator (111) further manages multi-record viewers such as grid and map views. For example, when the response includes a Lucene query or a list of record identifiers, the grid viewer may be activated to display tabular data, while the map viewer may be used for entities with spatial geometry, such as Facility, SurfaceLocation, or SeismicSurvey. In one or more embodiments, the view coordinator (111) may use a rules-based system to match schema types to viewer types. The view coordinator may dynamically switch between viewers based on user interaction. For instance, a user may click on a record in a grid view, prompting the view coordinator to open a log viewer if the record corresponds to log data. This orchestration facilitates seamless navigation across different data representations and ensures that the most contextually appropriate viewer is rendered for each data type.

The view coordinator (111) orchestrates diverse viewing tools (e.g., viewing tool 1 (108), viewing tool N (109)) of the included in the application computing system (110). The viewing tools may be configured to interpret data and present a particular visualization for the type of data. The viewing tools may operate in preview mode, which displays lightweight embedded views such as thumbnails or links, and detail mode, which renders full-screen or split-screen views for deeper interaction.

The viewing tools used may include document viewing tools, log viewing tools, grid viewing tools, map viewing tools, image viewing tools, trace viewing tools, and chart viewing tools. The orchestration of the viewing tools by the view coordinator (111), entails determination of the appropriate viewer configuration using metadata (137) and data element(s) (136) from the data payload (135).

More particularly, in the case of grid viewing tools, the visualization of the data payload may be a multiple-record view showing tabular or grid-based outputs for broad searches or listings. In one or more embodiments, a grid viewing tool may be activated specifically when a Lucene query is present in the query response. The grid viewing tool may configure column headers by analyzing the fields returned in the query, checking cached configurations, and fetching schema or view configurations. A grid view rendered by the grid viewing tool may serve as a launch point for further interactions, such as selecting a record to open in a more specialized viewer (e.g., log or map viewer). Additionally, the grid view may serve as a launch point for custom actions like “Create Data Package” or “Export CSV” based on action identifiers and payloads received in the query response.

The application computing system (110) further includes a workflow coordinator (116). The workflow coordinator (116) is software or application-specific hardware, which, when executing on a computer processor orchestrates the execution of one or more workflow tools (e.g., workflow tool 1 (114), workflow tool N (115)). The workflow coordinator (116) orchestrates the workflow tools based on inputs received from the action resolver and the LLM-powered search engine (112). In one or more embodiments, when a user query results in an action recommendation that involves triggering a domain-specific workflow, the workflow coordinator (116) interprets the recommendation and determines the appropriate execution path. The execution path may entail launching a domain application interface, invoking a backend API endpoint, or initiating a multi-step data processing routine. The workflow coordinator (116) checks that the inputs, such as schema-specific parameters, contextual metadata, and user selections, are available and correctly formatted before initiating the workflow.

In embodiments where workflows are tied to oil and gas domain operations, the workflow coordinator (116) may manage tasks such as opening well log interpretation tools, initiating reservoir modeling applications, or exporting structured data into formats compatible with external systems. The workflow coordinator (116) may operate in conjunction with the conversational context to maintain continuity across sessions, ensuring that workflow execution reflects the current state of the user's interaction. In one or more embodiments, the workflow coordinator (116) may orchestrate one or more workflow tools 1 (114) through workflow tools N (115).

The workflow tools (e.g., workflow tool 1 (114), workflow tool N (115)) are executable components that perform domain-specific operations based on instructions received from the workflow coordinator (116). The workflow tools may be invoked when the LLM-powered search engine (112) returns an action recommendation indicating that a user intends to perform a task beyond data viewing, such as exporting data, enriching records, or initiating a domain workflow. Workflow tools may include backend services, API endpoints, or full-featured domain applications that operate on structured or unstructured data retrieved during the search process. For example, a workflow tool may be responsible for generating a CSV file from a set of well log records, launching a reservoir modeling interface, or executing a seismic data interpretation routine.

Each workflow tool is designed to accept specific input parameters, which may include record identifiers, schema types, user selections, and contextual metadata. The input parameters may be validated by the screening tool (107) prior to invocation of the workflow tool. The workflow tools may further operate in coordination with the conversational context. The integration with conversational context facilitates complex, multi-step operations, transitioning between search, visualization, and workflow execution.

While FIG. 1 shows a configuration of components, other configurations may be used without departing from the scope of one or more embodiments. For example, various components may be combined to create a single component. As another example, the functionality performed by a single component may be performed by two or more components.

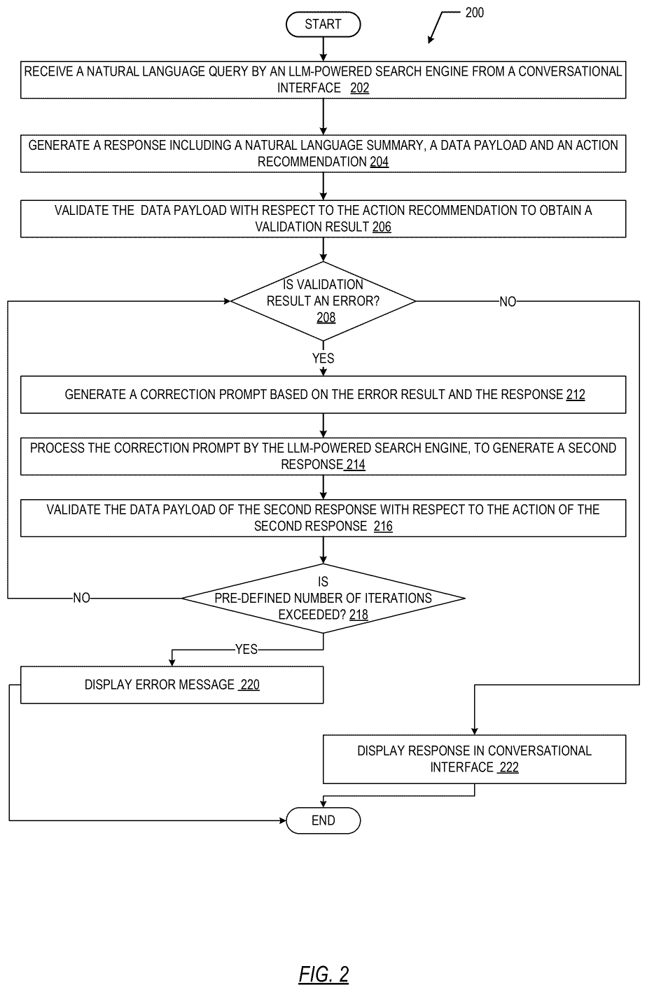

FIG. 2 shows a flowchart 200 of a method for self-correcting action invocation from responses generated by an LLM-powered search engine, in accordance with one or more embodiments. The method of FIG. 2 may be implemented using the system of FIG. 1 and one or more of the steps may be performed on or received at one or more computer processors. While the various steps in the flowchart 200 are presented and described sequentially, at least some of the steps may be executed in different orders, may be combined or omitted, and at least some of the steps may be executed in parallel. Furthermore, the steps may be performed actively or passively.

In Block 202, a natural language query is received by an LLM-powered search engine from a conversational interface. The conversational interface may be presented as a first section of a user interface. The natural language query may be expressed in natural language and may request information, or data visualization, or execution of a workflow.

In Block 204, a response is generated by the LLM-powered search engine. In one or more embodiments, the first response may include a natural language summary, a data payload, and an action recommendation. The natural language summary may include a reference to a data element within the data payload. The action recommendation may describe a workflow action or a viewer action.

In Block 206, the data payload may be validated with respect to the action recommendation to obtain a validation result. In one or more embodiments, the validation may be performed by the screening tool, which may extract the data payload from the first response and apply a type-specific validation check. The type-specific validation check may be selected based on the type of the data payload. In one or more embodiments, the type-specific validation check may include at least an image data validation check, a plot data validation check, a database query validation check, and a domain workflow parameter check. Other type-specific validation checks may be possible. In one or more embodiments, the validation checks performed by the screening tool may be extensible, depending on the new schema types being added to the enterprise system.

In Block 208, a determination is made as to whether the validation result is an error result. If the validation result is not an error, the method continues to Block 222. If the validation result is an error, the method continues to Block 212.

In Block 212, a correction prompt may be generated by a correction LLM. The correction prompt may be based on the error result and the first response. In one or more embodiments, the prompt may include a natural language summary of the error, the data payload of the first response, a conversation history comprising a user state and an action state, and an instruction requesting regeneration of the response.

In Block 214, the correction prompt may be processed by the LLM-powered search engine to generate a second response. The second response may include a second data payload and a second action recommendation.

In Block 216, the second data payload of the second response may be validated with respect to the second action recommendation to obtain a second validation result. The validation may follow the same type-specific checks as described in Block 206.

In Block 218, a determination may be made as to whether a pre-defined number of iterations has been exceeded. If the iteration limit has not been reached, control may then pass to Block 208, in which another determination is made as to whether the second data payload passes the validation check. If the iteration limit has been exceeded, the process may proceed to Block 220. In Block 220, an error response may be generated and displayed in the conversational interface. The error response may include a notification indicating failure to validate, a summary of attempted corrections, and a request for additional user input.

In Block 222, after the validation result has been determined to be a success result, the natural language summary of the first response may be displayed in the conversational interface. The summary may include a reference to either a data element of the data payload or to the action recommendation of the first response. The action recommendation may include a workflow action or a viewing action. The conversational interface may be monitored to detect a selection of the reference. Upon receiving the selection, a workflow type of the action recommendation may be identified. A workflow tool may be invoked to perform a workflow corresponding to the workflow type, using the data payload of the first response to obtain an output of the workflow tool. A second reference to the output of the workflow tool may be displayed in the conversational interface, and the user interface may be monitored to detect a selection of the second reference.

If the reference corresponds to a data element, a viewer type corresponding to the data element may be identified. A viewing tool associated with the viewer type may be invoked to generate a visualization of the data element. In one or more embodiments, during generation of the visualization, a particular viewing tool may identify nested data elements within the data element. For example, the data element may be a set of structured records, and a particular field of a structured record may represent a data entity of a different schema type. The particular field may be associated with a different viewing tool. In one example, the data element may include a multitude of well logs presented in a grid view or a map view. Each well log may be selectable to open an individual well log view, which may display log curves or trajectory data specific to that well. Accordingly, when generating the visualization, the nested data element may be embedded in a nested reference in the visualization, facilitating further interaction and exploration of the underlying data.

The visualization may be rendered in a first viewer section of the user interface. The visualization may include a nested reference to the nested data element, for the user to navigate between related data entities through successive viewer interactions. Accordingly, the first viewer section may be monitored for user interactions to detect a second selection of a second data element.

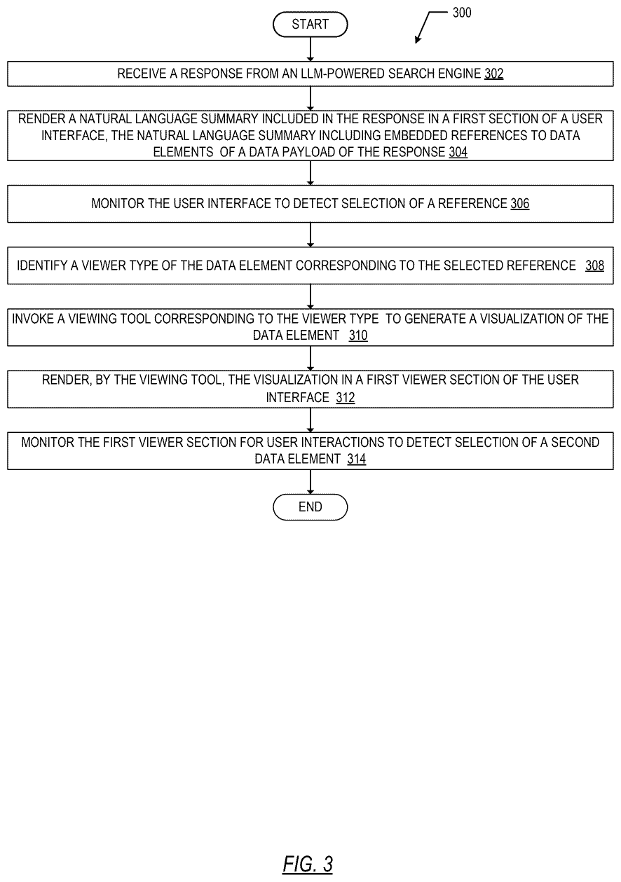

FIG. 3 shows a flowchart 300 of the working of the view coordinator in orchestrating and generating views related to data payloads of the responses of the LLM-powered search engine, in accordance with one or more embodiments. The method of FIG. 3 may be implemented using the system of FIG. 1 and one or more of the steps may be performed on or received at one or more computer processors. While the various steps in the flowchart 300 are presented and described sequentially, at least some of the steps may be executed in different orders, may be combined or omitted, and at least some of the steps may be executed in parallel. Furthermore, the steps may be performed actively or passively.

In Block 302, a response is received from an LLM-powered search engine. The response may include a natural language summary, a data payload, and an action recommendation. The natural language summary may include a reference to a data element of the data payload.

In Block 304, the natural language summary included in the response may be rendered in a first section of a user interface of a user application. The reference to the data element may be embedded in a corresponding widget. The widget may serve as an interactive element that allows the user to engage with the referenced data element. In one or more embodiments, the widget may include a preview of the visualization of the data element.

In Block 306, the user interface may be monitored to detect a selection of the corresponding widget of the reference. The selection may indicate a user's intent in viewing or interacting with the data element.

In Block 308, upon detecting the selection of the corresponding widget, a viewer type corresponding to the data element may be identified. The viewer type may be determined based on the schema type associated with the data element. A mapping between schema types and viewer types may be used to select the appropriate viewing tool.

In Block 310, a viewing tool corresponding to the identified viewer type may be invoked to generate a visualization of the data element. The viewing tool may be selected and executed based on the schema type and viewer mapping. The data element may include image data, plot data, a database query, database records, or document identifiers.

In Block 312, the visualization generated by the viewing tool may be rendered in a first viewer section of the user interface. The first viewer section may be a distinct area of the user interface designated for displaying visualizations.

In Block 314, the first viewer section may be monitored for user interactions to detect selection of a second widget. The second widget may embed a second reference to a second data element. This interaction may trigger further viewer coordination, causing the view coordinator to respond to nested or sequential data exploration. In one or more embodiments, a nested data element may be identified and embedded in a nested widget in the visualization. The visualization of the data element may include the nested widget to facilitate deeper interaction.

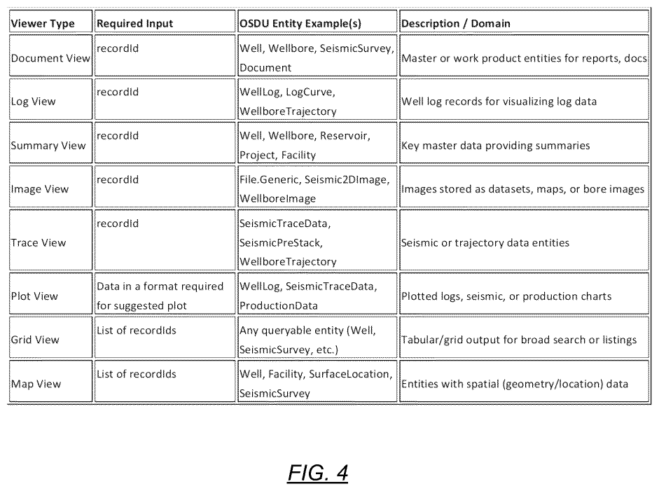

FIG. 4 shows an example of a viewer type catalog, maintained by the system to map schemas to viewer types, in accordance with one or more embodiments. The following example is for explanatory purposes, and not intended to limit the scope of one or more embodiments.

The column “viewer type” lists the diverse viewers that may be utilized to render visualizations in viewer sections of the user interface. The viewer types correspond to the viewing tools that may be invoked by the view coordinator. Associated with each viewer type is a corresponding input, shown in the “Required Input” column. The “Required Input” column indicates the specific data input that constitutes the content, or what is being displayed by a particular viewing tool. The input originates from schema entities, shown in the column “OSDU Entity Example(s).” For example, a document view may display a document identified by recordId, from well or wellbore schemas, or seismic survey schemas. The “Description/Domain” column indicates the nature of the input and schema.

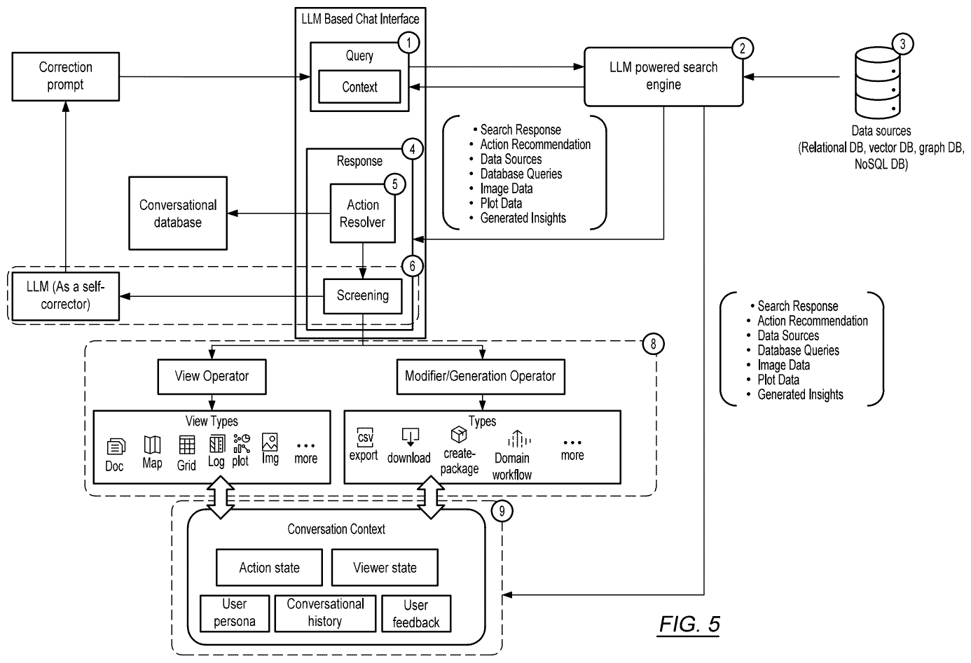

FIG. 5 shows an example of an implementation of the system of FIG. 1, namely, a generative AI-powered system for conversational data interaction, validation, and visualization, in accordance with one or more embodiments. The following example is for explanatory purposes and not intended to limit the scope of one or more embodiments.

The system shown in FIG. 4 may be deployed within a chat-based application designed to support domain experts, such as data managers in the oil and gas industry, by enabling natural language querying, dynamic viewer orchestration, and action execution.

In Block 1, an LLM-based chat interface may receive a natural language query. The interface may include components for managing the query and context, allowing the user to express information specifications in conversational form. The context may include prior interactions, user persona, viewer state, and action state.

In Block 2, the query may be processed by an LLM-powered search engine. The search engine may generate a response that includes a natural language summary, a data payload, and an action recommendation. The data payload may include structured and unstructured data retrieved from multiple data sources shown in block 3, including relational databases, vector databases, graph databases, and NoSQL databases. The response may also include generated database queries, image data, plot data, and insights derived from the underlying data.

In Block 4, the response may be passed to the action resolver and screening components. The action resolver may interpret the action recommendation and determine whether the action involves viewing data or performing certain workflow actions on the data. The screening component may validate the data payload with respect to the recommended action. Validation checks may include image decoding and format verification, plot data structure validation (e.g., equal-length arrays), and database query syntax analysis (e.g., Lucene or SQL). Further, if the action recommendation is a workflow action, the validation checks may be performed for completeness of domain workflow parameters (e.g., pressure and temperature values), and presence of data for package creation or export.

If a validation check fails, an error code may be generated. Error codes may include “IMAGE NOT FOUND,” “PLOT DATA INCORRECT,” “INVALID QUERY SYNTAX,” “DOMAIN WORKFLOW ERROR,” “CREATE PACKAGE ERROR,” etc. The type-specific error codes may inform the screening tool, and the LLM acting as a self-corrector of the exact nature of the error encountered while performing the validation check. The correction LLM, with knowledge of the type-specific error codes, may dynamically generate the appropriate correction prompt.

In Block 5, the error code and original response may be passed to an LLM acting as a self-corrector. The self-corrector may access the conversational database to retrieve historical context, user feedback, and prior viewer, or action states. A correction prompt may be generated based on the error and the original response. The correction prompt may include a summary of the error, the original data payload, and an instruction to regenerate the response. The corrected prompt may be processed again by the LLM-powered search engine to produce a revised response. This correction loop may iterate until a valid response is obtained or a pre-defined limit is reached.

In Block 6, the view operator may be invoked to determine the appropriate viewer type based on the schema of the data element. Viewer types may include: document viewers (DOC, PDF), spreadsheet viewers (XLS), presentation viewers (PPT), image viewers (IMG), video viewers (VID), audio viewers (AUD), code viewers (CODE), package viewers (PKG), 3D model viewers (3D), table views for structured data, map views for spatial data, log viewers for wellbore or seismic data, plot viewers for charted insights, etc.

Nested data elements may be embedded within visualizations. For example, a grid view displaying a list of well logs may allow selection of an individual log to open a detailed log viewer. A field within a structured record may represent a data entity of a different schema type and may be associated with a different viewing tool. The visualization may include nested widgets referencing these nested data elements.

In Block 7, the modify/generation operator may be activated to perform client-side actions such as exporting data, downloading data packages, or converting data types. Supported formats may include standard structured formats such as CSV, XLSX; standard unstructured formats such as PDF, DOCX, TXT; semi-structured formats such as JSON, XML, HTML; standard image formats such as GIF, JPG, PNG, SVG, BMP, TIFF; and standard audio/video formats such as WAV, MP4, MOV, MKV, MPEG-TS, WebM, AAC, MIDI, and WMA. The client-side actions may be implemented by the workflow tools performing one or more workflow operations. The workflow operations may be triggered based on the action recommendation and may operate on the validated data payload.

In Block 8, the conversation context is stored and maintained, to support intelligent orchestration of viewer tools and domain workflows. The conversation context may include action state, viewer state, user persona, conversational history, and user feedback. The conversation context may be stored in a conversational database and used to inform future search requests and viewer behavior.

Within the conversation context, the action state may track the most recent action recommendation and its execution status. The viewer state may include parameters such as the current page number for document viewers, zoom level for map viewers, selected records in grid views, and displayed logs in log viewers. The user persona may reflect domain-specific preferences or roles, such as a geoscientist or data manager, which may influence the type of data retrieved and the viewers invoked. The conversational history may include prior queries and responses, and the user feedback may include explicit ratings or selections that guide future recommendations.

Domain workflows may be triggered based on the action recommendation included in the LLM-powered search engine's response. A domain workflow may be invoked in diverse ways. In one mode, the system may launch a domain-specific application interface, such as a well log interpretation tool or a seismic analysis platform, using the data payload as input. In another mode, the system may call an API endpoint associated with the domain workflow, passing structured parameters such as pressure, temperature, or well identifiers. The modifier/generation operator may determine the appropriate invocation method based on the workflow type and the completeness of the input parameters.

The screening module may validate whether the inputs for the workflow are present. If any parameters are missing or malformed, the system may generate a “DOMAIN WORKFLOW ERROR” and initiate a correction loop. The correction LLM may analyze the error and generate a revised prompt to regenerate the response with the missing inputs. This process may continue until the workflow can be successfully executed or a pre-defined iteration limit is reached.

The system architecture depicted in the diagram demonstrates a modular and extensible framework. The integration of conversational context, dynamic viewer invocation, domain workflow execution, and self-correcting logic implements robust handling of complex data interactions in a domain-specific environment.

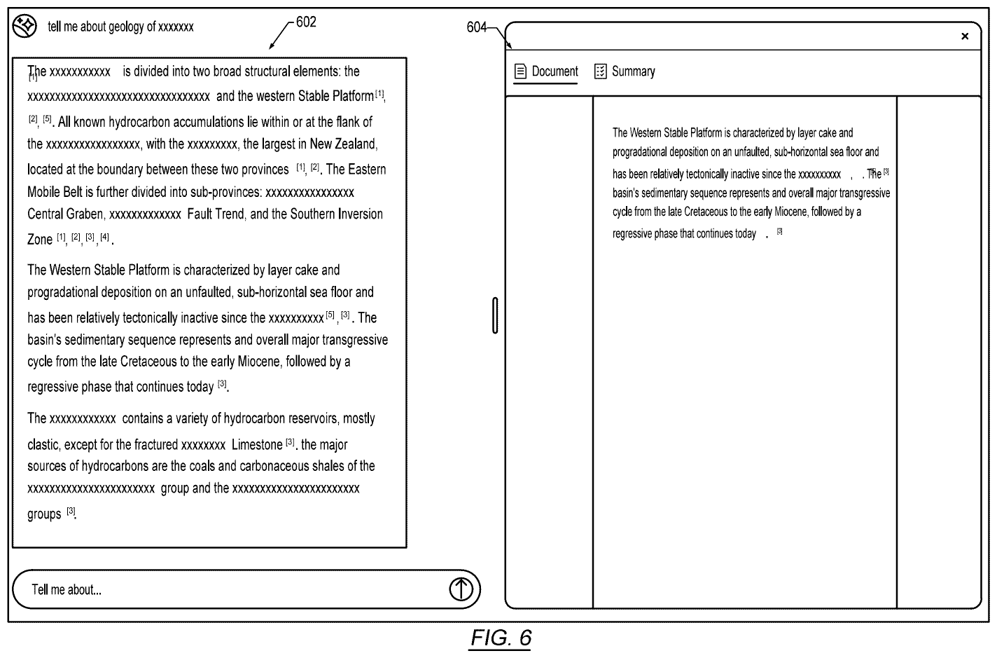

FIGS. 6, 7, and 8 show examples of the user interface, showing the conversational interface section and viewer sections displaying diverse data views in accordance with one or more embodiments. The following examples are for explanatory purposes and not intended to limit the scope of one or more embodiments.

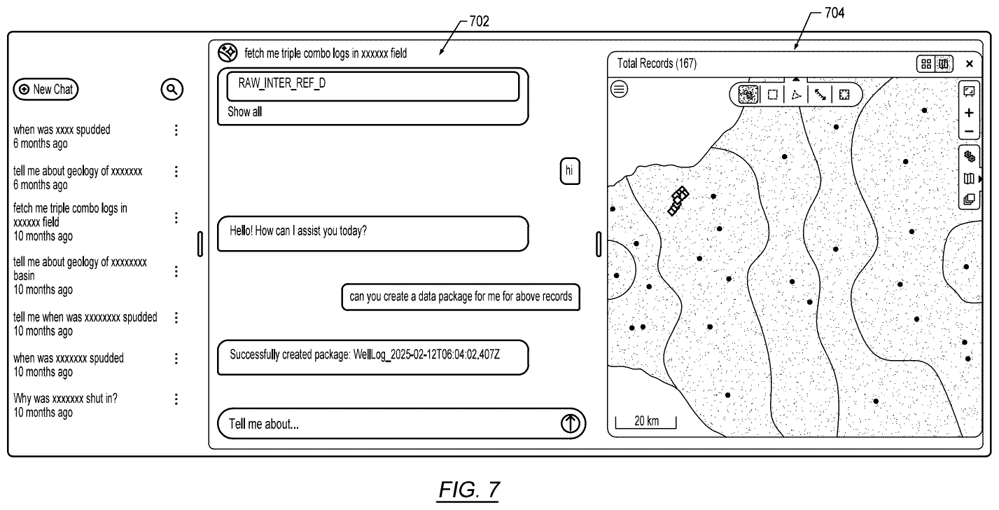

FIG. 6 shows a seismic survey document in the viewer section (section 604). The seismic survey document is displayed by a document viewing tool, operating and controlling the viewer section. The natural language summary of the seismic survey document is shown in section 602, namely, the conversational interface. In like manner, in FIG. 7, section 702 shows the conversational interface. Section 702 includes a history of natural language queries and responses, such as requests for geological information, log data, and update timestamps. The generative AI-powered assistant responds with confirmations and summaries, including successful actions like creating data packages. Section 704 displays a map interface that visualizes geographical data corresponding to the user's queries. The map interface is interactive, showing spatial records, including coordinates (e.g., longitude −174.4314 and latitude −39.1712). The total number of records retrieved (187) is additionally indicated. Section 704 includes tools for interacting with the map, such as zoom, selection, and filtering based on location or data type.

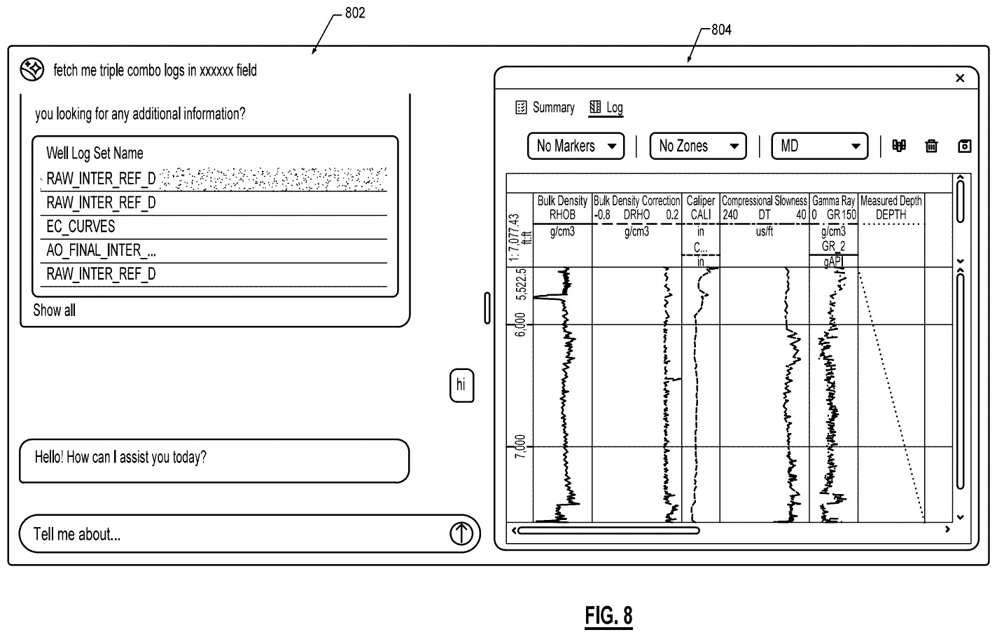

In FIG. 8, section 802 displays a list of well log set names, which represent different data groupings or sources associated with well logging operations. The diverse entries indicate various stages or types of processed and raw log data available for selection or visualization. Section 804 shows the actual well log curves plotted against measured depth. The plotted curves represent different physical measurements taken during well logging, including Bulk Density (RHOB), Bulk Density Correction (DRHO), Caliper (CALI), Compressional Slowness (DT), and Gamma Ray (GR). Each log is visualized as a graph, for interpretation of subsurface properties and identification of geological formations or anomalies.

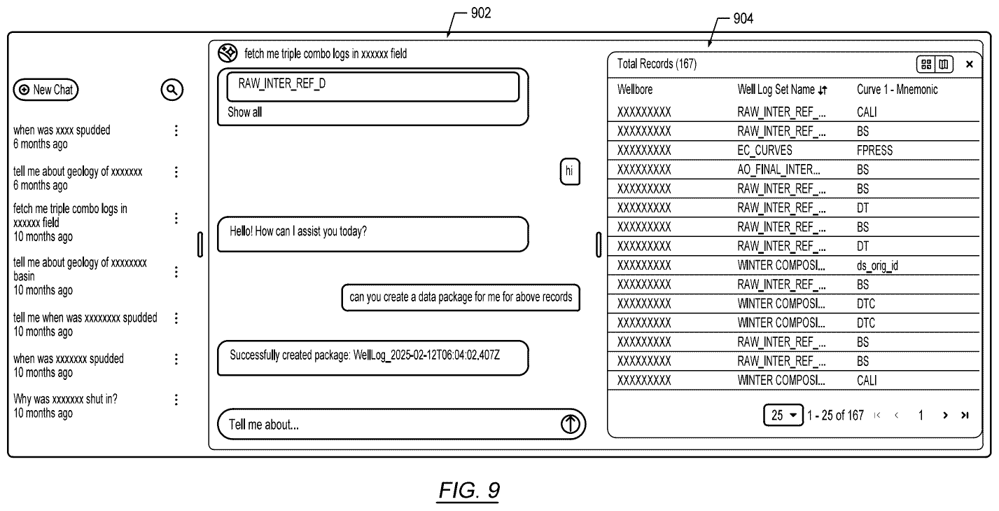

FIG. 9 shows an example of a workflow action requested by the user, and the resulting action completion and view transition, in accordance with one or more embodiments. The following example is for explanatory purposes and not intended to limit the scope of one or more embodiments.

Section 902 shows the conversational interface, where the user interacts with an AI assistant to request well log data and initiate actions. The conversation includes natural language queries such as “fetch me triple combo logs” and “can you create a data package for me for above records.” The assistant responds with relevant log set names and confirms the successful creation of a data package, indicating that the system supports operational execution through conversational input.

Section 904 displays a tabular interface listing the results of the user's query. The table is titled “Total Records (167)” and includes columns for Wellbore, Well Log Set Name, and Curve 1-Mnemonic. The entries show various combinations of log sets and curve identifiers, such as RAW_INTER_REF_D with CALI and BS, EC_CURVES with FPRESS, and AO_FINAL_INTER with BS. This section provides a structured view of the retrieved data and includes pagination controls for navigating through multiple pages of records.

One or more embodiments may be implemented on a computing system specifically designed to achieve an improved technological result. When implemented in a computing system, the features and elements of the disclosure provide a technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 10.1, the computing system (1000) may include one or more computer processor(s) (1002), non-persistent storage device(s) (1004), persistent storage device(s) (1006), a communication interface (1008) (e.g., Bluetooth interface, infrared interface, network interface, optical interface, etc.), and numerous other elements and functionalities that implement the features and elements of the disclosure. The computer processor(s) (1002) may be an integrated circuit for processing instructions. The computer processor(s) (1002) may be one or more cores, or micro-cores, of a processor. The computer processor(s) (1002) includes one or more processors. The computer processor(s) (1002) may include a central processing unit (CPU), a graphics processing unit (GPU), a tensor processing unit (TPU), combinations thereof, etc.

The input device(s) (1010) may include a touchscreen, keyboard, mouse, microphone, touchpad, electronic pen, or any other type of input device. The input device(s) (1010) may receive inputs from a user that are responsive to data and messages presented by the output device(s) (1012). The inputs may include text input, audio input, video input, etc., which may be processed and transmitted by the computing system (1000) in accordance with one or more embodiments. The communication interface (1008) may include an integrated circuit for connecting the computing system (1000) to a network (not shown) (e.g., a local area network (LAN), a wide area network (WAN) such as the Internet, mobile network, or any other type of network) or to another device, such as another computing device, and combinations thereof.

Further, the output device(s) (1012) may include a display device, a printer, external storage, or any other output device. One or more of the output device(s) (1012) may be the same or different from the input device(s) (1010). The input device(s) (1010) and output device(s) (1012) may be locally or remotely connected to the computer processor(s) (1002). Many different types of computing systems exist, and the aforementioned input device(s) (1010) and output device(s) (1012) may take other forms. The output device(s) (1012) may display data and messages that are transmitted and received by the computing system (1000). The data and messages may include text, audio, video, etc., and include the data and messages described above in the other figures of the disclosure.

Software instructions in the form of computer-readable program code to perform embodiments may be stored, in whole or in part, temporarily or permanently, on a non-transitory computer-readable medium such as a solid state drive (SSD), compact disk (CD), digital video disk (DVD), storage device, a diskette, a tape, flash memory, physical memory, or any other computer-readable storage medium. Specifically, the software instructions may correspond to computer-readable program code that, when executed by the computer processor(s) (1002), is configured to perform one or more embodiments, which may include transmitting, receiving, presenting, and displaying data and messages described in the other figures of the disclosure.

The computing system (1000) in FIG. 10.1 may be connected to, or be a part of, a network. For example, as shown in FIG. 10.2, the network (1020) may include multiple nodes (e.g., node X (1022) and node Y (1024), as well as extant intervening nodes between node X (1022) and node Y (1024)). Each node may correspond to a computing system, such as the computing system shown in FIG. 10.1, or a group of nodes combined may correspond to the computing system shown in FIG. 10.1. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (1000) may be located at a remote location and connected to the other elements over a network.

The nodes (e.g., node X (1022) and node Y (1024)) in the network (1020) may be configured to provide services for a client device (1026). The services may include receiving requests and transmitting responses to the client device (1026). For example, the nodes may be part of a cloud computing system. The client device (1026) may be a computing system, such as the computing system shown in FIG. 10.1. Further, the client device (1026) may include or perform at least a portion of the operations described herein.

The computing system of FIG. 10.1 may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being a single element unless expressly disclosed, such as by the use of the terms “before,” “after,” “single,” and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited by the attached claims.

What is claimed is:

1. A method comprising:
receiving, by an LLM-powered search engine, a natural language query from a conversational interface, wherein the conversational interface is a first section of a user interface;
generating, by the LLM-powered search engine, a first response comprising a natural language summary, a data payload and an action recommendation;
validating the data payload with respect to the action recommendation to obtain a validation result; and
responsive to the validation result being an error result, performing operations comprising:
generating, by a correction LLM, a correction prompt based on the error result and the first response,
processing, by the LLM-powered search engine, the correction prompt to generate a second response, and
validating a second data payload of the second response with respect to a second action recommendation of the second response, to obtain a second validation result.

2. The method of claim 1, further comprising:
extracting, by a screening tool, from the first response, the data payload; and
validating, by the screening tool, the data payload with respect to the action recommendation, wherein the validation comprises:
performing a type-specific validation check of the data payload, based on a type of the data payload; wherein the type-specific validation check comprises an image data validation check, a plot data validation check, a database query validation check, and a domain workflow parameter check.

3. The method of claim 1, further comprising:
responsive to the data payload of the first response failing a type-specific validation check, generating a type-specific error code, corresponding to the type-specific validation check, wherein the type-specific error code is the error result; and
transmitting the type-specific error code, and the data payload to the correction LLM.

4. The method of claim 1, further comprising:
generating, by the correction LLM, a prompt including a natural language summary of a type-specific error code, the data payload of the first response, a conversation history comprising a user state and an action state, and an instruction comprising a request to regenerate the response.

5. The method of claim 1, further comprising:
iteratively performing:
validating the data payload of the first response with respect to the action recommendation of the first response to obtain the validation result; and
responsive to the validation result being the error result, performing operations comprising:
generating, by the correction LLM, a correction prompt based on the error result and the first response, and
processing, by the LLM-powered search engine, the correction prompt to generate a second response;
for a pre-defined number of iterations.

6. The method of claim 5, further comprising:
responsive to the pre-defined number of iterations being performed, and the validation result being the error result, generating an error response; and
displaying the error response in the conversational interface.

7. The method of claim 1, further comprising:
responsive to the validation result being a success result, performing operations comprising:
displaying the natural language summary of the first response in the conversational interface, wherein the natural language summary of the first response includes a reference to the action recommendation of the first response, wherein the action recommendation comprises a workflow action, and
monitoring the conversational interface to detect a selection of the reference.

8. The method of claim 7, further comprising:
receiving, from the conversational interface, the selection of the reference;
identifying a workflow type of the action recommendation of the first response;
invoking a workflow tool to perform a workflow corresponding to the workflow type, using the data payload of the first response to obtain an output of the workflow tool;
displaying a second reference to the output of the workflow tool in the conversational interface; and
monitoring the user interface to detect a selection of the second reference.

9. The method of claim 1, further comprising:
responsive to the validation result being a success result, performing operations comprising:
displaying the natural language summary in the conversational interface, wherein the natural language summary includes a reference to a data element of the data payload of the first response, and
monitoring the user interface to detect a selection of the reference.

10. The method of claim 1, further comprising:
receiving, from the user interface, a selection of a reference to a data element of the data payload of the first response, wherein the reference is included in the natural language summary;
identifying a viewer type corresponding to the data element;
invoking a viewing tool corresponding to the viewer type to generate a visualization of the data element;
rendering, by the viewing tool, the visualization in a first viewer section of the user interface; and
monitoring the first viewer section of the user interface for user interactions to detect a second selection of a second data element.

11. The method of claim 10, further comprising:
identifying a nested data element, wherein the nested data element is included in the data element; and
generating the visualization of the data element, wherein the visualization further comprises a nested reference to the nested data element.

12. A system, comprising:
at least one computer processor;
a user application, executing on the at least one computer processor;
a correction LLM, executing on the at least one computer processor; and
an LLM-powered search engine, executing on the at least one computer processor and configured for:
receiving a natural language query from a conversational interface, wherein the conversational interface is a first section of a user interface of the user application, and
generating a first response comprising a natural language summary, a data payload and an action recommendation; and
wherein the user application is configured for:
validating, by a screening tool of the user application, the data payload with respect to the action recommendation to obtain a validation result, and
responsive to the validation result being an error result, performing operations comprising:
obtaining, from the correction LLM, a correction prompt based on the error result and the first response,
obtaining a second response, generated by the LLM-powered search engine processing the correction prompt, and
validating, by the screening tool, a second data payload of the second response with respect to a second action recommendation of the second response, to obtain a second validation result.

13. The system of claim 12, further configured for:
extracting, by the screening tool, from the first response, the data payload; and
validating, by the screening tool, the data payload with respect to the action recommendation, wherein the validation comprises:
performing a type-specific validation check of the data payload, based on a type of the data payload, wherein the type-specific validation check comprises an image data validation check, a plot data validation check, a database query validation check, and a domain workflow parameter check;
responsive to the data payload of the first response failing the type-specific validation check, generating a type-specific error code, corresponding to the type-specific validation check, wherein the type-specific error code is the error result; and
transmitting the type-specific error code, and the data payload to the correction LLM.

14. The system of claim 12, further configured for:
generating, by the correction LLM, a prompt including a natural language summary of a type-specific error code, the data payload of the first response, a conversation history comprising a user state and an action state, and an instruction comprising a request to regenerate the response.

15. The system of claim 12, further configured for:
iteratively performing:
validating, by the screening tool, the data payload of the first response with respect to the action recommendation of the first response to obtain the validation result; and
responsive to the validation result being the error result, performing operations comprising:
generating, by the correction LLM, a correction prompt based on the error result and the first response, and
processing, by the LLM-powered search engine, the correction prompt to generate a second response;
for a pre-defined number of iterations; and
responsive to the pre-defined number of iterations being performed, and the validation result being the error result, generating an error response; and
displaying the error response in the conversational interface.

16. The system of claim 12, further configured for:
responsive to the validation result being a success result, performing operations comprising:
displaying, the natural language summary of the first response in the conversational interface, wherein the natural language summary of the first response includes a reference to the action recommendation of the first response, and wherein the action recommendation comprises a workflow action,
monitoring the conversational interface to detect a selection of the reference,
receiving, by a workflow coordinator, from the conversational interface, the selection of the reference,
identifying, by the workflow coordinator, a workflow type of the action recommendation of the first response,
invoking, by the workflow coordinator, a workflow tool to perform a workflow corresponding to the workflow type, using the data payload of the first response, to obtain an output of the workflow tool,
displaying a second reference to the output of the workflow tool in the conversational interface, and
monitoring the user interface to detect a selection of the second reference.

17. The system of claim 12, further configured for:
responsive to the validation result being a success result, performing operations comprising:
displaying the natural language summary in the conversational interface, wherein the natural language summary includes a reference to a data element of the data payload of the first response, and
monitoring the user interface to detect a selection of the reference.

18. The system of claim 12, further configured for:
receiving, by a view coordinator, from the user interface, a selection of a reference to a data element of the data payload of the first response, wherein the reference is included in the natural language summary;
identifying, by the view coordinator, a viewer type corresponding to the data element;
invoking, by the view coordinator, a viewing tool corresponding to the viewer type to generate a visualization of the data element;
rendering, by the viewing tool, the visualization in a first viewer section of the user interface; and
monitoring the first viewer section of the user interface for user interactions to detect a second selection of a second data element.

19. The system of claim 18, further configured for:
identifying, by the view coordinator, a nested data element, wherein the nested data element is included in the data element; and
generating, by the viewing tool, the visualization of the data element, wherein the visualization further comprises a nested reference to the nested data element.

20. A non-transitory computer-readable medium storing instructions that, when executed by at least one computer processor, cause the at least one computer processor to perform operations comprising:
receiving, by an LLM-powered search engine, a natural language query from a conversational interface, wherein the conversational interface is a first section of a user interface;
generating, by the LLM-powered search engine, a first response comprising a natural language summary, a data payload and an action recommendation;
validating the data payload with respect to the action recommendation to obtain a validation result; and
responsive to the validation result being an error result, performing operations comprising:
generating, by a correction LLM, a correction prompt based on the error result and the first response,
processing, by the LLM-powered search engine, the correction prompt to generate a second response, and
validating a second data payload of the second response with respect to a second action recommendation of the second response, to obtain a second validation result.
